(19) United States
(12) Patent Application Publication
(10) Pub. No.: US 2006/0132933 A1
(43) Pub. Date: Jun. 22, 2006

(54) Lens apparatus

(75) Inventors: Junichi Nio, Chiba (JP); Hisatsugu Yoshida, Chiba (JP); Shuji Ogino, Kyoto (JP)

Correspondence Address: MICHAUD-DUFFY GROUP LLP, 306 INDUSTRIAL PARK ROAD, SUITE 206, MIDDLETOWN, CT, 06457, US

(73) Assignee: Seiko Precision Inc., Chiba (JP)

(21) Appl. No.: 11/347,629

(22) Filed: Feb. 3, 2006

Related U.S. Application Data
(63) Continuation of application No. 10/521,627, filed on Sep. 14, 2005.

(30) Foreign Application Priority Data
Jul. 18, 2002 (JP) 2002-209547
Jul. 18, 2002 (JP) 2002209547

(51) Int. Cl. G02B 9/34

(52) U.S. Cl. 359/771

(57) ABSTRACT

From an object, a first lens that is a meniscus lens having a convex surface that faces an object, a second lens that faces a concave surface of the first lens, a third lens having a concave surface that faces the second lens, and a fourth lens that is a positive lens having a convex back surface, (1) ν3<ν4, (2) 0.5<Ymax/f<0.8, and (3) Σd<1.5f are satisfied, where ν3 is an Abbe number of the third lens, ν4 is an Abbe number of the fourth lens, Ymax is a maximum height of an image, f is a composite focal length, Σd is a distance between a first surface of the first lens and a second surface of the fourth lens, the first surface facing the object and the second surface facing an imaging plane, any one surface of the first lens and the fourth lens having a non-spherical surface.

### TECHNICAL FIELD

This invention generally relates to a lens device, and more particularly, to a lightweight and small-sized lens apparatus that can be mounted on a portable computer, a mobile telephone, or the like.

### BACKGROUND ART

Conventionally, small-sized and lightweight lens apparatuses that are mounted on super compact cameras, mobile telephones, and the like are disclosed in Japanese Patent Application Publication No. 4-211215 and Japanese Patent Application Publication No. 6-88939. Each of the above-mentioned lens apparatuses is composed of one or two lenses. However, peripherals of the image are greatly deteriorated in quality, and accordingly, a satisfactory image quality cannot be obtained when the above-mentioned lens apparatus is employed in an image sensor for taking an image having a large number of pixels, more than one million pixels.

Generally, five or six lenses were required to obtain a sufficient resolution as a lens apparatus in use for a one-quarter-size image sensor, which is used for taking the image having one to two million pixels. It was thus difficult to downsize and reduce weight.

In addition, in the case where a field angle is wide, 50 degrees or more, it has extremely been difficult to correct distortion aberration or color aberration or coma aberration in the peripherals of the image.

### DISCLOSURE OF THE INVENTION

It is a general object of the present invention to provide a lens apparatus that is capable of solving the above-mentioned drawbacks.

According to the lens apparatus of the present invention, the number of lenses is four or less, a distance between a first surface facing an object and an second surface facing an imaging plane is set to 1.5f or less.

On the bases of an intersection of an axis (light ray) and a chief ray of most off-axis light rays, the aberration generated by a group of lenses provided in front of the intersection is corrected by another group of lenses provided behind the intersection, and the fourth lens maintains a position of exit pupil to be longer. It is possible to maintain an optimal correction of a lateral chromatic aberration and transverse chromatic aberration by keeping Abbe number of the third and fourth lenses within ranged of given formulas.

### BRIEF DESCRIPTION OF THE DRAWINGS

Preferred embodiments of the present invention will be described in detail with reference to the following drawings, wherein:

FIG. 1 is a structure of a lens apparatus in accordance with a first embodiment of the present invention; and

FIG. 2 shows a lens aberration in accordance with the first embodiment of the present invention.

### BEST MODE FOR CARRYING OUT THE INVENTION

A description will now be given, with reference to the accompanying drawings, of embodiments of the present invention.

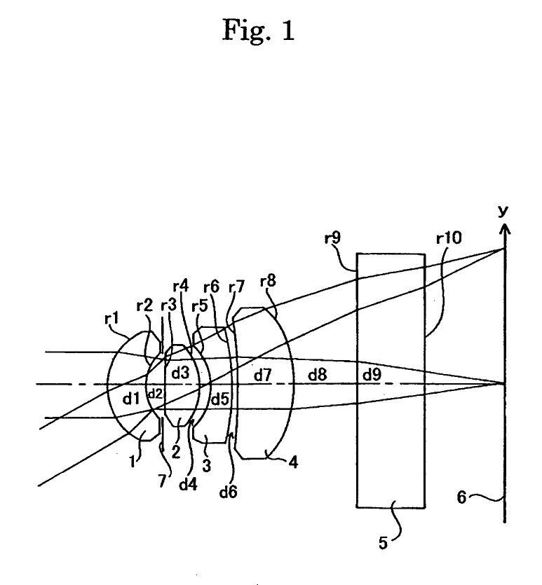

Referring to FIG. 1, the lens apparatus in accordance with the present invention includes a first lens 1, a second lens 2, a third lens 3, and a fourth lens 4, which are arranged in an order from an object. The first lens 1 is a meniscus lens made of glass having a convex surface that faces the object. The second lens 2 is made of glass, is arranged next to the first lens 1, and has a convex back surface that faces an imaging plane. The third lens 3 is made of polycarbonate-based resin, is arranged next to the second lens 2, and has a concave surface that faces the object. The fourth lens 4 is made of glass, is arranged next to the third lens 3, and has the convex surface that faces the imaging plane. The first lens 1 has a first surface that faces the object. The fourth lens 4 has a second surface that faces the imaging plane. Both of the first and second surfaces have non-spherical shapes, and are configured to satisfy following conditions.
ν3<4 (1)
0.5<Ymax/f<0.8 (2)
Σd<1.5f (3)

In the above-mentioned conditions, ν3 denotes an Abbe number of the third lens 3, ν4 denotes another Abbe number of the fourth lens 4, Ymax/f denotes a maximum height of the image, f denotes a composite focal length, and Σd denotes a distance between the first surface in the first lens and the second surface in the fourth lens, the first surface facing the object and the second surface facing the imaging plane.

Table 1 shows a detailed explanation.

TABLE 1

| Radius of | | | |
|---|---|---|---|
| Curvature | Distance | Refractive | Abbe Number |
| (ri) | (di) | Index (ni) | (ν1) |
| r1 = 1.034 | d1 = 0.63 | n1 = 1.58913 | ν1 = 61.3 |
| r2 = 0.78 | d2 = 0.25 | | |
| Diaphragm | | | |
| r3 = 130.326 | d3 = 0.64 | n2 = 1.58913 | ν2 = 61.3 |
| r4 = −1.132 | d4 = 0.1 | | |
| r5 = −0.922 | d5 = 0.4 | n3 = 1.585 | ν3 = 30 |
| r6 = −4.255 | d6 = 0.03 | | |
| r7 = −6.055 | d7 = 0.95 | n4 = 1.58913 | ν4 = 61.3 |
| r8 = −1.467 | d8 = 0.5 | | |
| r9 = ∞ | d9 = 1.0 | nf = 1.5168 | |
| r10 = ∞ | | | |

Non-spherical Coefficient

| | ε | a | c |
|---|---|---|---|
| r1 | 1.439127 | 0.5705e−02 | −0.1204e−02 |
| r2 | 2.4248 | −0.57017e−01 | −0.2326e+01 |
| r3 | 1.0 | −0.79051e−01 | 0.4611 |
| r4 | 2.2523 | −0.17911 | −0.9416 |
| r5 | −0.002 | −0.2405 | −0.52979 |
| r8 | −0.0007 | −0.5558e−02 | 0.5024e−02 |

The focal length of the entire lens: f=3.685, FNO=3.5, and the field angle: 61.6

In the case where a z-axis is a direction of an optical axis, x-axis is vertical to the optical axis, the light travels in the positive direction, and ε, a, b, c, and d are non-spherical coefficients, the following formula is described.

$$Z = \frac{\frac{{x}^{2}}{r}}{1 + \sqrt{1 - ɛ \frac{{x}^{2}}{{r}^{2}}}} + {ax}^{4} + {bx}^{6} + {cx}^{8} + {dx}^{10} + Λ$$

The referential number ri in FIG. 1 and Table 1 defines the radius of curvature of the i-th surface from the object. In the same manner, the referential number di defines a distance on the axis between the i-th surface and the i+1-th surface from the object. The referential numbers n1 through n4 respectively define the refractive index of a d-line in the first lens 1, the second lens 2, the third lens 3, and the fourth lens 4. The referential numbers v1 through v4 define the Abbe numbers.

In addition, next to the fourth lens 4, an IR cut filter 5 is arranged on the side of an imaging plane 6. A CCD, which is an example of shooting element, is installed next to the IR cut filter 5 on the side of the imaging plane 6. Only the imaging plane 6 of the CCD is shown. A light ray control unit 7 is provided between the first lens 1 and the second lens 2. The light ray control unit serves as a lens diaphragm.

A light path in this lens structure in accordance with the present invention is also shown in FIG. 1. A chief ray of the light rays having the maximum height of the image passes through the vicinity of the light ray control unit 7, which is provided behind the first lens 1. A front group of the diaphragm (the first lens 1 in accordance with the present invention) and a back group (the second through fourth lenses in accordance with the present invention) cancel the aberration each other.

In the lens structure in accordance with the present invention, the small-sized, lightweight, and low-cost shooting lens can thus be obtained. An exit pupil of the shooting lens is sufficiently longer than the composite focal length, and this compact shooting lens has the wide field angle of 50 degrees or more. In addition, approximately 50 percent of luminance ratio is obtainable in the maximum height of the image, and the resolution around the peripherals of the image (MTF) is 150 lines per millimeter. The lens apparatus having such a high resolution of 50 percent or more is thus obtainable.

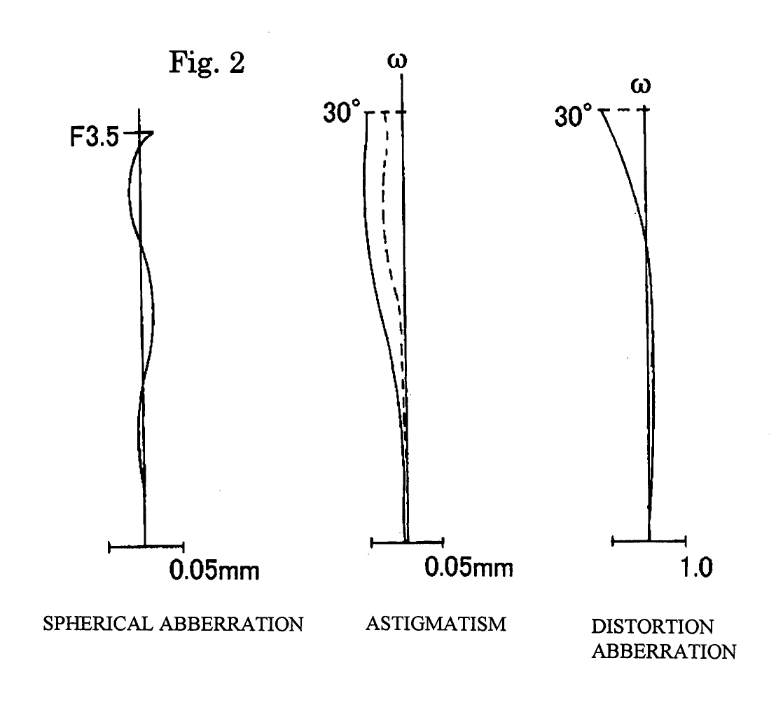

FIG. 2 shows aberrations in accordance with the first embodiment of the present invention. As shown in FIG. 2, it is possible to obtain the lens apparatus having little spherical aberration, astigmatism, and distortion aberration. The lens apparatus has little color aberration, which is not shown.

In the lens structure in accordance with the present invention, negative effects of the concave lens of the third lens 3 play an important role in correcting the aberration. The third lens 3 has a concave surface that faces to the object. The second lens 2 relays the rays of light from the first lens 1 to the third lens 3. The aberration including the first lens 1 and the second lens 2 is absorbed on the concave surface of the third lens 3.

With respect to the correction of the color aberration in the lens structure in accordance with the present invention, the third lens 3 and the fourth lens 4 cancel each other. The color aberration can be corrected sufficiently by satisfying ν3<ν4.

Tables 2, 3, and 4 show the detailed elements in accordance with second, third, and fourth embodiments, respectively. The lens structure in accordance with the second, the third, and the fourth embodiments, which are not shown, are same as that in the first embodiment of the present invention. It is possible to obtain the lens apparatus that is capable of correcting the aberrations sufficiently and has the resolution of 150 lines per millimeter. The lens apparatus having a high resolution is obtainable.

TABLE 2

| Radius of | | | |
|---|---|---|---|
| Curvature | Distance | Refractive | Abbe Number |
| (ri) | (di) | Index (ni) | (v1) |
| r1 = 1.162 | d1 = 0.63 | n1 = 1.6935 | v1 = 53.3 |
| r2 = 0.949 | d2 = 0.29 | | |
| Diaphragm | | | |
| r3 = −21.21 | d3 = 0.5 | n2 = 1.53039 | v2 = 55.8 |
| r4 = −1.4 | d4 = 0.08 | | |
| r5 = −0.93 | d5 = 0.3 | n3 = 1.585 | v3 = 30 |
| r6 = 8.541 | d6 = 0.03 | | |
| r7 = 5.083 | d7 = 0.95 | n4 = 1.6935 | v4 = 53.3 |
| r8 = −1.52 | d8 = 0.5 | | |
| r9 = ∞ | d9 = 1.0 | nf = 1.5168 | |
| r10 = ∞ | | | |

Non-spherical Coefficient

| | ε | a | c |
|---|---|---|---|
| r1 | 1.704343 | 0.10247e−01 | 0.72515e−03 |
| r2 | 3.13227 | −0.15884e−01 | −0.95365 |
| r3 | 1.0 | −0.39518 | 0.152767 |
| r4 | 4.20229 | −0.249413 | −0.170572e+01 |
| r5 | 0.026948 | −0.393033 | −0.1555e+01 |
| r6 | 1.0 | −0.2497e−01 | −0.15731e−01 |
| r7 | 1.0 | 0.24118e−01 | 0.7077e−02 |
| r8 | −0.009549 | 0.731e−02 | 0.2944e−01 |

The focal length of the entire lens: f=3.682, FNO=3.5, and the field angle: 66.7

In accordance with the second embodiment of the present invention, the second lens is made of cycloolefin-based resin. The third lens is made of the polycarbonate-based resin. The first lens 1 and the fourth lens 4 are made of glass.

TABLE 3

| Radius of | | | |
|---|---|---|---|
| Curvature | Distance | Refractive | Abbe Number |
| (ri) | (di) | Index (ni) | (v1) |
| r1 = 1.054 | d1 = 0.65 | n1 = 1.58913 | v1 = 61.3 |
| r2 = 0.927 | d2 = 0.21 | | |
| Diaphragm | | | |
| r3 = 16.874 | d3 = 0.7 | n2 = 1.53039 | v2 = 55.8 |
| r4 = −1.124 | d4 = 0.1 | | |
| r5 = −0.896 | d5 = 0.5 | n3 = 1.585 | v3 = 30 |
| r6 = −13.972 | d6 = 0.04 | | |
| r7 = −5.207 | d7 = 1.02 | n4 = 1.58913 | v4 = 61.3 |
| r8 = −1.273 | d8 = 0.5 | | |
| r9 = ∞ | d9 = 1.0 | nf = 1.5168 | |
| r10 = ∞ | | | |

Non-spherical Coefficient

| | ε | a | c |
|---|---|---|---|
| r1 | 1.086439 | 0.27211e−01 | 0.445e−01 |
| r2 | 2.52395 | −0.49324e−01 | −0.205717e+01 |
| r4 | 2.13567 | 0.15612 | −0.142107 |
| r6 | 1.0 | −0.72885e−01 | 0.7911e−02 |
| r8 | 0.30816 | −0.409e−03 | 0.4196e−02 |

The focal length of the entire lens: f=3.678, FNO=3.5, and the field angle: 61.3

In accordance with the third embodiment of the present invention, the second lens is made of cycloolefin-based resin. The third lens is made of the polycarbonate-based resin. The first lens 1 and the fourth lens 4 are made of glass.

TABLE 4

| Radius of | | | |
|---|---|---|---|
| Curvature | Distance | Refractive | Abbe Number |
| (ri) | (di) | Index (ni) | (v1) |
| r1 = 1.045 | d1 = 0.63 | n1 = 1.58913 | v1 = 61.3 |
| r2 = 0.887 | d2 = 0.25 | | |
| Diaphragm | | | |
| r3 = −15.547 | d3 = 0.64 | n2 = 1.58913 | v2 = 61.3 |
| r4 = −1.422 | d4 = 0.1 | | |
| r5 = −1.042 | d5 = 0.4 | n3 = 1.585 | v3 = 30 |
| r6 = −11.164 | d6 = 0.03 | | |
| r7 = −9.921 | d7 = 0.95 | n4 = 1.58913 | v4 = 61.3 |
| r8 = −1.329 | d8 = 0.5 | | |
| r9 = ∞ | d9 = 1.0 | nf = 1.5168 | |
| r10 = ∞ | | | |

Non-spherical Coefficient

| | ε | a | c |
|---|---|---|---|
| r1 | 1.400562 | 0.18058e−01 | 0.27879e−01 |
| r2 | 2.94814 | −0.7715e−02 | −0.146311e+01 |
| r3 | 1.0 | 0.102458 | 0.21433e+01 |
| r4 | 2.66328 | 0.113946 | −0.121192e+01 |
| r5 | −0.037086 | −0.197711 | −0.1162e+01 |
| r6 | 1.0 | −0.576e−01 | 0.38232e−01 |
| r7 | 1.0 | 0.79477e−01 | 0.7293e−03 |
| r8 | 0.018252 | −0.78839e−03 | 0.18164e−01 |

The focal length of the entire lens: f=3.685, FNO=3.5, and the field angle: 61.6

In accordance with the fourth embodiment of the present invention, the third lens is made of the polycarbonate-based resin. The first lens 1, the second lens 2, and the fourth lens 4 are made of glass.

In accordance with the present embodiment of the present invention, neither the first surface of the first lens 1 that faces the object nor the second surface of the fourth lens 4 that faces the imaging plane has a spherical surface. However, there is no limitation to the above-mentioned non-spherical surface. Any one of the first lens 1 and the fourth lens 4 may have the non-spherical surface.

In accordance with the present invention, it is possible to obtain the lens apparatus made of four lenses that is small-sized, lightweight, and low-cost. The field angle is at least 50 degrees, the luminance ratio is approximately 50 percent, and the peripherals of the image also have high resolutions.

The present invention is not limited to the above-mentioned embodiments, and other embodiments, variations and modifications may be made without departing from the scope of the present invention.

1. A lens apparatus comprising: a first lens that is a meniscus lens having a convex surface that faces an object; a second lens that faces a concave surface of the first lens; a third lens having a concave surface that faces the second lens; and a fourth lens that is a positive lens having a convex back surface,
wherein following conditions are satisfied,
ν3<ν4 (1)
0.5<Ymax/f<0.8 (2)
Σd<1.5f (3)
where ν3 is an Abbe number of the third lens, ν4 is an Abbe number of the fourth lens, Ymax is a maximum height of an image, f is a composite focal length, Ed is a distance between a first surface of the first lens and a second surface of the fourth lens, the first surface facing the object and the second surface facing an imaging plane, any one surface of the first lens and the fourth lens having a non-spherical surface.

2. The lens apparatus as claimed in claim 1, wherein the second lens has a convex back surface that faces the imaging plane.

3. The lens apparatus as claimed in claim 1 further comprising a light ray control unit provided between the first lens and the second lens.

4. The lens apparatus as claimed in claim 1 further comprising an optical filter provided between the fourth lens and the imaging plane.
